(19) United States
(12) Patent Application Publication
(10) Pub. No.: US 2016/0148140 A1
(43) Pub. Date: May 26, 2016

(54) LOAD-CONSTRAINED SERVICE FACILITY PLACEMENT

(71) Applicants: Hao WU, Beijing (CN); Boyi NI, Shanghai (CN); Wen-Syan LI, Shanghai (CN)

(72) Inventors: Hao WU, Beijing (CN); Boyi NI, Shanghai (CN); Wen-Syan LI, Shanghai (CN)

(21) Appl. No.: 14/549,480

(22) Filed: Nov. 20, 2014

(51) Int. Cl. G06Q 10/06; G06Q 50/26

(52) U.S. Cl. CPC G06Q 10/06315; G06Q 50/26

(57) ABSTRACT

A framework for optimized service facility placement is provided. Load constraints of each service facility are factors of the overall optimization. In various implementations, one or more iterative algorithms are used in the optimization of efficient facility placement.

### TECHNICAL FIELD

The present disclosure relates generally to service facility placement and more specifically to a framework for optimizing service facility placement.

### BACKGROUND

Service facility placement, or location facility placement, includes finding a set of K facilities, each facility serving a limited group of clients, which can cover all the clients and minimize the cost to the clients to obtain services. Real-world applications include the placements of communication stations, emergency medical centers, warehouses, security sentries, etc.

Current placement strategies often neglect an important factor—the load constraint(s) of the facilities. In real world applications, each facility generally has its own maximum ability of serving clients. For example, each communication station has its maximum throughput rate, a warehouse has a limited space for storing materials, police and security sentries can cover a limited amount of territory in a shift, etc.

While services from certain facilities may be utilized in other locations, or be arranged to serve alternate clients, exceeding the maximum capacity of the facilities while leaving other facilities under-used can result in extreme inefficiency.

### SUMMARY

A load-constrained service facility placement framework is described herein. In accordance with one implementation, the framework selects random locations for a plurality of service facilities, and assigns clients to the service facilities, each client being assigned to a service facility nearest to the client. The framework may further calculate a center location of all of the clients assigned to the service facility, update a location of the service facility to the calculated center location, reassign all clients to the relocated service facilities, each client assigned to a service facility nearest to the client, and balance a service load across all service facilities.

With these and other advantages and features that will become hereinafter apparent, further information may be obtained by reference to the following detailed description and appended claims, and to the figures attached hereto.

### BRIEF DESCRIPTION OF THE DRAWINGS

The Detailed Description is set forth with reference to the accompanying figures. In the figures, the left-most digit(s) of a reference number identifies the figure in which the reference number first appears. The use of the same reference numbers in different figures indicates similar or identical items.

FIG. 1 is a block diagram of an example computing system environment.

FIG. 2 is a diagram of an example service facility placement without regard to load-constraints.

FIG. 3 is a diagram of an example service facility placement, illustrating relatively equal distribution of loads among service facilities.

FIG. 4A is a diagram of an example service environment, such as a city layout, for example.

FIG. 4B is a modeled graph diagram of the road network of the city layout of FIG. 4A.

FIG. 5 is a diagram of the example service environment model of FIG. 4B, illustrating a technique of finding a center node of multiple event spots.

FIG. 6 is a flow diagram illustrating an example process for optimizing service facility placement.

### DETAILED DESCRIPTION

Various techniques and systems for optimizing service facility placement are disclosed, according to example implementations. In various implementations, load constraints of each service facility are factors of the overall optimization. In an implementation, one or more iterative algorithms are used to factor in the loads in the optimization, for efficient facility placement.

For example, in an implementation, iterative techniques used by the systems calculate a center location of all clients assigned to a service facility (e.g., performed for each service facility). The location of the service facilities are updated to the newly calculated locations and all of the clients are reassigned to the service facilities, at their new locations. In one implementation, loads are balanced across all of the service facilities. In the implementation, the process of calculating a center location, updating the location of the service facilities, reassigning the clients, and balancing the loads repeats until convergence, when the changes to the service facility locations are insignificant (i.e., the changes are less than a threshold amount).

As an example, police substation (e.g., sentinel, precinct, etc.) placement is used to describe the techniques and systems applied herein. However, this is not intended to be limiting and the techniques and systems described herein are also applicable to many and various other facility placement scenarios (e.g., communication stations, emergency medical centers, warehouses, etc.).

Various techniques for optimizing service facility placement are disclosed. The discussion herein is intended to illustrate components and techniques which may be utilized in optimizing service facility placement according to a variety of applications, but the examples described are not intended to be limiting. In various implementations, fewer, alternate, or additional components may be included to perform various portions of described techniques while remaining within the scope of the disclosure.

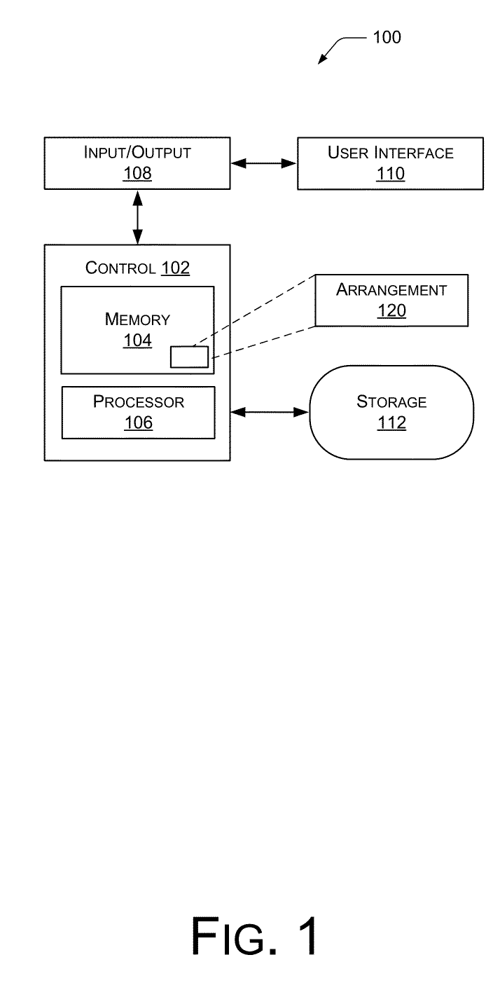

FIG. 1 shows an example of a system 100 wherein the techniques and devices discussed herein may be implemented. In the example, the system 100 uses a control module 102, for example, to perform computational, analytical, and control functions for the system 100. As shown in FIG. 1, the control module 102 may include a memory 104 and one or more processors 106, as are described further below. In various implementations, the system 100 includes an input/output (I/O) module 108, a user interface (UI) 110, and may also include a storage component 112.

In an implementation, the memory 104 comprises one or more types of hardware memory storage devices (fixed or portable), or the like. In the implementation, one or more inputs (such as geo-location information) are loaded into the memory 104 for access by the processor 106 while running an application. In one implementation, the application may also be stored in the form of computer-executable instructions within the memory 104.

In an implementation, the processor 106 performs load-constrained service facility placement via one or more algorithms, as part of running the application, which include techniques for determining and optimizing loads across all service facilities.

In an implementation, the input/output module 108 can receive locational data for one or more objects over durations of time. The durations may be hours, days, weeks, months, years, or the like. The locational data may be collected from a service facility, for instance, particularly if the service facility is mobile or portable, and/or a client. In an implementation, the locational data comprises spatial-temporal data, or the like. In one example, the locational data may comprise a time stamp and a location of a mobile service facility station, such as an emergency command post, etc.

In another example, the locational data includes global positioning satellite (GPS) data or signal triangulation information (e.g., radio frequency or other signal types, such as cellular, etc.) regarding the service facility. In an implementation, the memory 104 collects and stores the locational data received by the input/output module 108. In an implementation, the control module 102 (using the processor 106) is arranged to use the locational data to optimize service facility placement (e.g., to determine distances from the service facilities to the clients, etc.).

In an implementation, the storage 112 comprises one or more memory storage devices that are typically used for bulk data storage, and have a greater capacity as compared to the memory 104. A non-exhaustive list of storage 112 components includes: hard disk drives, floppy disk drives, optical drives, tape drives, and the like.

In various implementations, the system 100 may be connected to a network. In alternate implementations, the network may include a network such as an Ethernet Local Area Network (LAN), a token ring LAN, or other LAN, a Wide Area Network (WAN), a system area network, or other types of network, and can include several nodes or hosts (not shown). Moreover, the network can also include hardwired, optical, and/or wireless connection paths. In various implementations, the storage 112 may be located remotely, and accessed via the network (e.g., remote server, cloud storage, etc.).

In alternate implementations, the system 100 may be comprised of fewer or additional components, within which differently arranged structures may perform the techniques discussed within the disclosure.

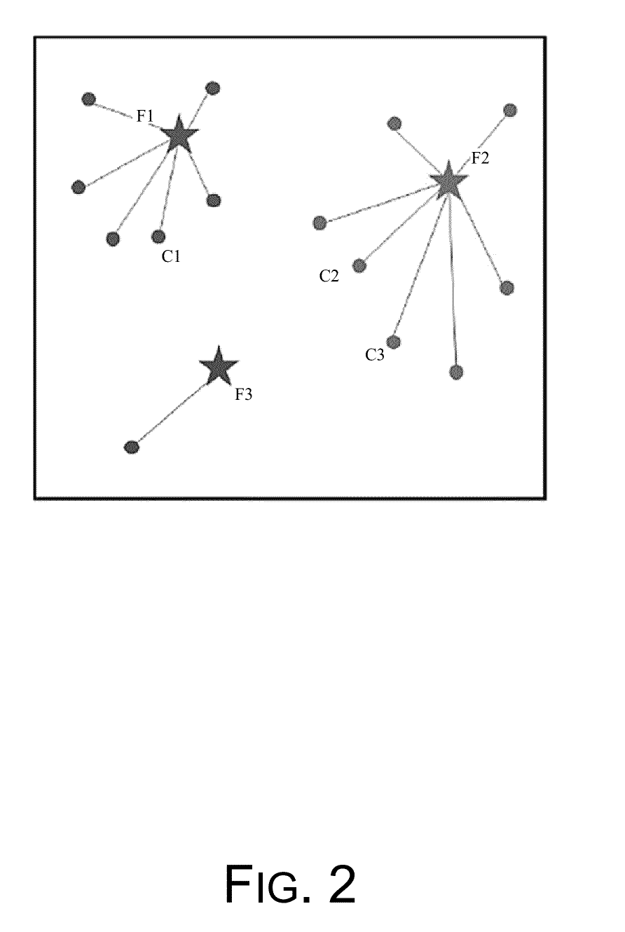

FIG. 2 is a diagram of an example service facility placement. The diagram of FIG. 1 illustrates facility placement without regard to load-constraints. For example, in the diagram of FIG. 1, circles represent clients and stars represent service facilities. If load constraints are not considered, as is indicated in FIG. 2, the loads of F1 and F2 are too heavy while the load of F3 is too light. Accordingly, the loads are not close to being balanced across the service facilities, and so the solution may not be optimal.

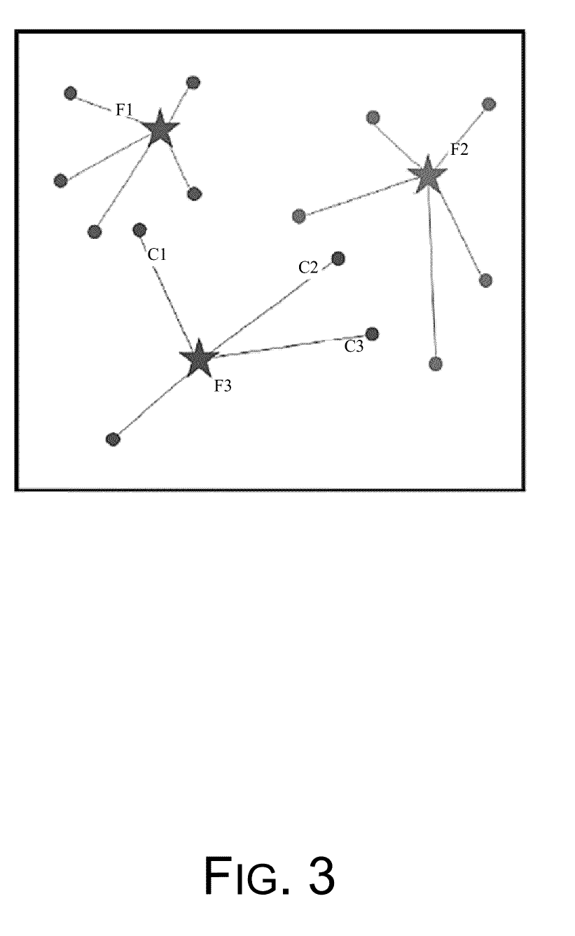

FIG. 3 is a diagram of an example service facility placement, illustrating relatively equal distribution of loads. This may be a better solution (though not necessarily the optimal solution), and includes rearranging clients C1, C2, and C3 to service facility F3. Accordingly, the loads are more balanced across the service facilities, and so the solution may be more efficient.

It can be proved (proof is omitted) that finding the optimal result of the facility placement problem of FIGS. 2 and 3 is NP-hard, i.e. the global optima of the problem cannot be found or verified in polynomial time, and it is even harder to guarantee the load balance constraint. Further, in real world applications, more complex situations are encountered, e.g. all clients may be located and inter-connected in a road network rather than in a simple Euclidean plane. Consequently, a more practical system may be based on those algorithms in theory.

In an implementation, with reference to FIG. 1, a system 100 may be employed with a load-constrained service facility placement arrangement (“arrangement”) 120, to find an acceptable result (i.e. a result close to the global optimal) of the service facility placement problem with load constraints. In an implementation, the arrangement 120 is part of the application loaded into the memory 104, and comprising computer-executable instructions. In one implementation, the arrangement 120 includes a technique of modifying a Lloyd's algorithm that solves the K-means clustering problem. With each iteration of the modified algorithm, cluster centers (i.e., facility locations) are updated, and also assignment of transfer data points (i.e. clients) between clusters are updated to maintain a predetermined load constraint.

As discussed further herein, the system 100, the arrangement 120, and the techniques can be applied to placement optimization of police substations in an area of a city. In the example, the system 100 and the arrangement 120 are designed to consider complex situations, such as the road network and various load distributions, etc. In alternate implementations, the system 100, arrangement 120, and techniques can be applied to other important service facility placement applications.

In an implementation, an arrangement 120 is used with a system 100 to optimize placement of service facilities (F1, F2, F3 . . . ), while considering load constraints. To set up the discussion of the arrangement 120, a formal definition of the load-constrained service facility placement problem is given herein.

For an example, notations of input and output data are given as follows:

Input:
N: Number of clients.
K: Number of facilities.
X={x₁, x₂, . . . , x_{N}}: Locations of clients.

Output:
[symbol] ={c₁, c₂, . . . , c_{K}}: Locations of facilities.
[symbol] ={aₙₖ}: Assignments of clients to facilities. aₙₖ=1 if client xₙ is assigned to facility cₖ, or 0 otherwise.
Further, the following restriction may be applied: ∀n, Σₖ aₙₖ=1. In other words, a client is assigned to only one facility at a time.

In the example, a description of a cost model is given as follows: Sₖ: The cost score of facility k. This value denotes the cost of obtaining services from cₖ by all of its assigned clients. Specifically, the cost score may be defined by the average of distances from clients to their corresponding service facility, i.e.:

$$\frac{{\sum }_{{a}_{ik} = 1} dist ( {c}_{k} , {x}_{i} )}{{\sum }_{{a}_{ik} = 1} 1}$$

The distance function can vary in different applications. For example, when looking at a communication station placement problem, the distance can be simply Euclidean distance. However, when considering the police substation placement problem, the distance function may be defined as road network distance, where S=>ₖ Sₖ may be the overall cost value.

In the example, Lₖ represents the load score of facility k. This value denotes the quantitative measurement of facility k's load, and its calculation is application-specific. For example, the number of clients assigned to facility k is the simplest definition of the load score.

The load-balancing penalty is represented by P=Σₖ|Lₖ/L−1/K|. In the example, this value is used to measure whether an assignment is a load-balancing assignment. If an assignment results in skewed loads of service facilities, this penalty value should be large.

The objective function is represented by J=λ·S+(1−λ)·P. With this objective function, the value of cost, S, and the value of load-balancing penalty, P, are integrated using a user-defined parameter λ. Specifically, λ takes the value between 0 and 1. When λ is close to 1, the solution tends to be one in which the overall cost is optimized; when λ is close to 0, the solution tends to be one in which the load of every service facility is balanced.

With the above definitions, a formal definition of the load-constrained service facility placement problem can be stated as follows:
Definition 1—Given locations of a set of clients X and the number of service facilities K, solving the load-constrained service facility placement problem is to find an assignment A and the set of service facility locations C, such that the objective function value J is minimized.

The above definition is a very general definition of the problem. For any specific application, the definition is to be adapted in terms of the distance calculation in cost score, the load score calculation, and the load-balancing penalty calculation. For example, when solving the police substation placement problem, each substation can be regarded as a facility and each event spot as a client, and the above three calculations can be defined as follows.

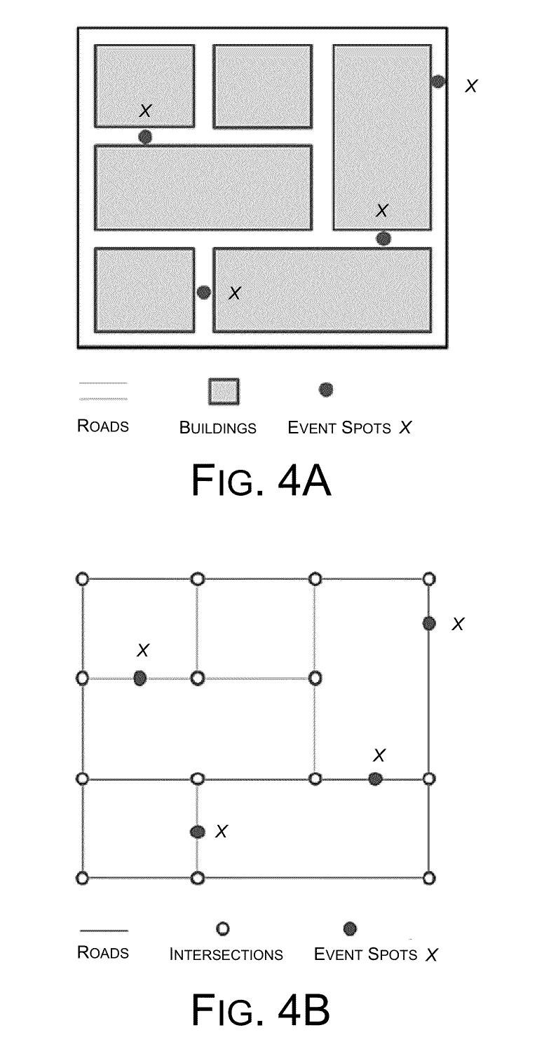

In an implementation, referring to FIGS. 4A and 4B, distance measurement is determined as road network distance. Conceptually, a whole city can be modeled as a giant road network, in which buildings, intersections, event spots, and police substations are vertices and roads connecting them are edges. The distance from a police substation c to an event spot x is defined as the shortest path from node c to node x, i.e.:
dist(c, x)=Length of shortest path from c to x.

The Load score of substation k (Lₖ) is defined by:

Lₖ=Σₐ_{ᵢₖ}₌₁dist(xᵢ,cₖ)

In other words, it is defined as the sum of distances of the substation c to all of its assigned event spots x. In the example, a policeman can be expected to respond to the requests of its entire set of assigned event spots x eventually. So the sum of distances represents the total (expected) load of each substation c.

In the example, the Load-balancing penalty (P) is the same as its original definition. However, in the real world, the maximum ability of one policeman is different from that of another, so it is also reasonable to consider a load distribution over all substations.

In various implementations, the components and modules of the arrangement 120 may be embodied in hardware and software components. For example, in the embodiments, the components and modules may include hardware components residing in the control 102 or processor 106 and/or may include computer executable instructions stored in memory 104 and operable on the processor 106 to perform the functions described.

In various implementations, the arrangement 120 uses one or more algorithms to optimize service facility placement. In one implementation, an example optimization algorithm includes modifying a Lloyd's algorithm. For example, a high level description of an implementation of this algorithm is illustrated as follows:

Algorithm 1: Example Optimization Algorithm

| | |
|---|---|
| 1. | Randomly choose locations for service facilities; |
| 2. | Assign clients to their nearest facilities; |
| 3. | Repeat: |
| 4. | For each facility: |
| 5. | Calculate the location of the center of all of its assigned clients; |
| 6. | Update the location of the facility to the new calculated center |
| | location; |
| 7. | Reassign clients to facilities; |
| 8. | Balance all facilities; |
| 9. | Until convergence. |

In an implementation, the optimization algorithm takes an iterative approach to find an optimized service facility placement. At first, it generates an initial solution by randomly choosing locations of facilities; and then, in each iteration step the algorithm improves the solution by relocating each facility and reassigning all clients. Using the algorithm, the objective function J is reduced after each iteration step. Finally, when the objective function does not change significantly after several iteration steps, the algorithm converges, which terminates the process. In an implementation, convergence comprises less than a predetermined threshold of change of the objective function J, after a preset quantity of iterations.

The 8-th line in the above example algorithm includes reassigning clients x to facilities c so that loads of all facilities c can be relatively more balanced. For example, this modification is a significant departure from a classic Lloyd's algorithm. An example load-balancing algorithm is illustrated as follows:

Algorithm 2: Example Balancing Algorithm

| | |
|---|---|
| 1. | Initialize an empty set [symbol] ; |
| 2. | For each facility c ∈ [symbol] : |
| 3. | If c's load is higher than average; |
| 4. | Put c into [symbol] ; |
| 5. | Repeat: |
| 6. | For each facility: |
| 7. | Find client x with the minimum transfer cost in [symbol] ; |
| 8. | Transfer x to its destination facility; |
| 9. | If J is larger than the previous iteration: |
| 10. | Put x back to its original facility; |
| 11. | Exit the loop; |
| 12. | Until load-balancing penalty P cannot be decreased. |

In the above load-balancing algorithm, the term ‘transfer’ includes reassigning a client to a new facility from its original facility. The cost of transferring a client x from facility c to facility c′ implies the benefit of improving the load balance. It is calculated by the formula:

$$TransferCost ( x , c ) = \{ dist ( {c}^{′} , x ) - dist ( c , x ) \} .$$

In an implementation, as is indicated in the above algorithm, the facility c to which the transfer cost of x is minimized is selected to be x's destination facility.

In the example, the techniques and systems described herein may be applied to the optimized placement of police substations (e.g., substations) within a city. Every city needs police forces to handle unexpected events happening all day at different locations. To guarantee a fast response, the urban security department can place a number of substations (i.e., service facilities c) throughout various parts of the city. Each substation location has one or more policemen. If any event happens, a policeman in the nearest substation is directed from the substation to the event spot as quickly as possible.

In the example, the problem of police substation placement is: given a set of pre-recorded event spots x and the number of substations c, find an optimal placement of these substations c such that 1) the overall expected response time in the future is minimized, and 2) every substation c has similar working load.

It can be seen that the police substation placement problem is equivalent to the general load-constrained facility placement problem discussed above. However, there can also be special issues corresponding to this specific application.

As is discussed above, distance measurement in the police substation placement problem differs from other applications. In an implementation, distance measurement is the length of shortest path in a road network. Conceptually, the road network in a city (shown at FIG. 4A) can be modeled as a giant graph (shown at FIG. 4B), in which every intersection or an event spot is a node and every road is an edge. In an example, edge lengths can be defined as the travel time from one node to another, instead of simply the Euclidean distance.

In various implementations, different techniques can be used to calculate the length of shortest path in a graph. For example, in one implementation, the classical Dijkstra algorithm can be used, or in other implementations, more modern shortest path query algorithms can be used that can improve calculation performance.

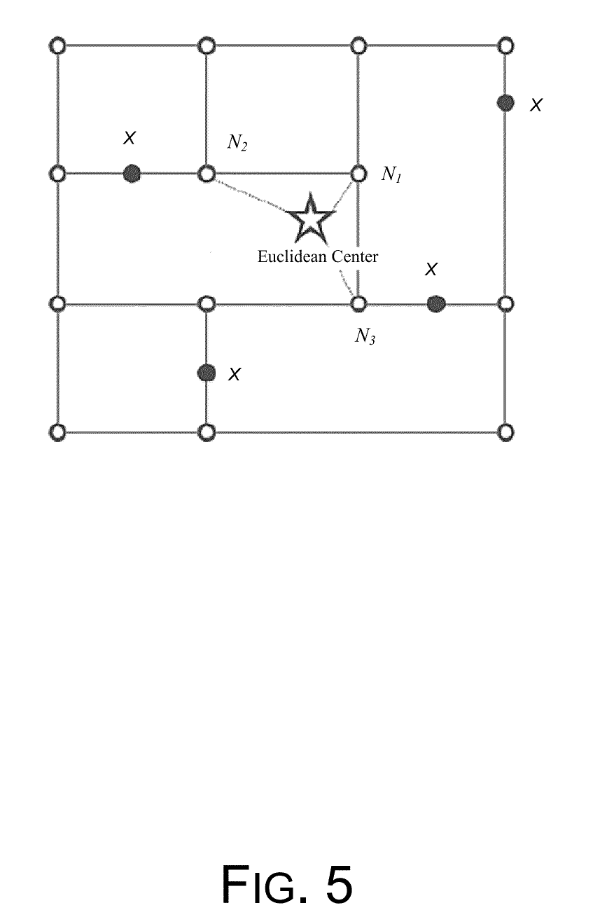

A side-effect of using this kind of distance definition is that the calculation of a new location for a substation when corresponding event spots are determined (as is indicated in line 6 in Algorithm 1) can be hard, since it is not trivial to find the center of a set of nodes in a graph. In an implementation, referring to FIG. 5, a heuristic method is used to find the approximation of the true center. The technique includes using the Euclidean center as the ‘seed’ center, and then iterate over its l nearest (in Euclidean space) graph nodes, and find the one with minimum sum of distances to all event spots to be the approximated center. In various implementations, this technique can find acceptable results.

As shown in FIG. 5, the arrangement 120 may use a technique to determine a center node of the 4 event spots x. First, the arrangement 120 determines the Euclidean center (marked by a star in the figure), and then finds the top-3 nearest nodes (marked N₁, N₂, and N₃ in the figure) to the Euclidean center as candidate nodes. Then, the arrangement 120 calculates the actual shortest paths, by summing the distances from each event spot x to each candidate node (N₁, N₂, N₃) in turn.

In an example, the sums may be calculated as: N₁: 3+5+3+5=16; N₂: 1+7+5+7=20; and N₃: 5+3+1+7=16. In one implementation, the arrangement 120 selects the candidate node (in this case, either N₁ or N₃) with the minimum sum of distances from the event spots x to the candidate nodes (N₁, N₂, N₃). In an implementation, as in this case, the arrangement 120 can select the first candidate node encountered as the center node (in this case N₁) of the event spots x.

As is discussed previously, a load score for a police substation c in the police substation placement problem is defined as the sum of distances from that substation c to all of its corresponding event spots x. If substations c have different numbers of policemen on duty, the overall load should not be distributed evenly over all substations c. Instead, each substation's load should be proportional to its number of policemen.

Specifically, taking the load distribution as an input:

$$B = 〈 {B}_{1} , {B}_{1} , … , {B}_{K} 〉 , where {B}_{k} = \frac{\# of policemen in sentinel k}{Total \# of policemen} ,$$

the load-balancing score can be calculated as follows:

P=Σₖ|Lₖ/L−Bₖ|.

In an implementation, it can be assumed that the number of policemen in each substation is pre-determined by the urban security department in the city, for example.

A unique feature of an urban security department is that their substation c placement can change from time to time. This can be due to at least two reasons: 1) the event x distribution over the city can change every day; and 2) the police power that can be used in the city can change for unexpected reasons. For example, there may be a very urgent event in the city, so that a large amount of policemen have been directed to the event spot x. In both of above cases, the placement of police substations c can be changed to maintain optimal response to incoming new events.

In an implementation, the arrangement 120 can be adapted to handle these cases. For the first case, in which the distribution of event spots x changes, the previous placement of the service facility c can be used as the initial solution, instead of using a randomly generated one (see line 1 in Algorithm 1). Then, algorithm 1 can be run without any change of any other parts. Since the distribution of event spots x over the city may not change so significantly, algorithm 1 can converge much faster than calculating from a random beginning.

For the second case, the arrangement 120 maintains the location of all substations c available in the city, and removes all unavailable substations c. This provides a new initial solution (see line 1 in Algorithm 1). In addition, load distribution is also recalculated according to the available set of policemen. Then, Algorithm 1 is run without change of any other part, till convergence. Similar to the first case, since the initial solution is already better than the randomly-generated one, the algorithm can converge faster than calculating from a random beginning.

In some circumstances, case 1 and case 2 may happen at the same time. In this situation, the process of handling these two cases simultaneously is straightforward—including updating the new set of event spots x, updating the substation c and policemen information, and then run Algorithm 1 without any change of other parts.

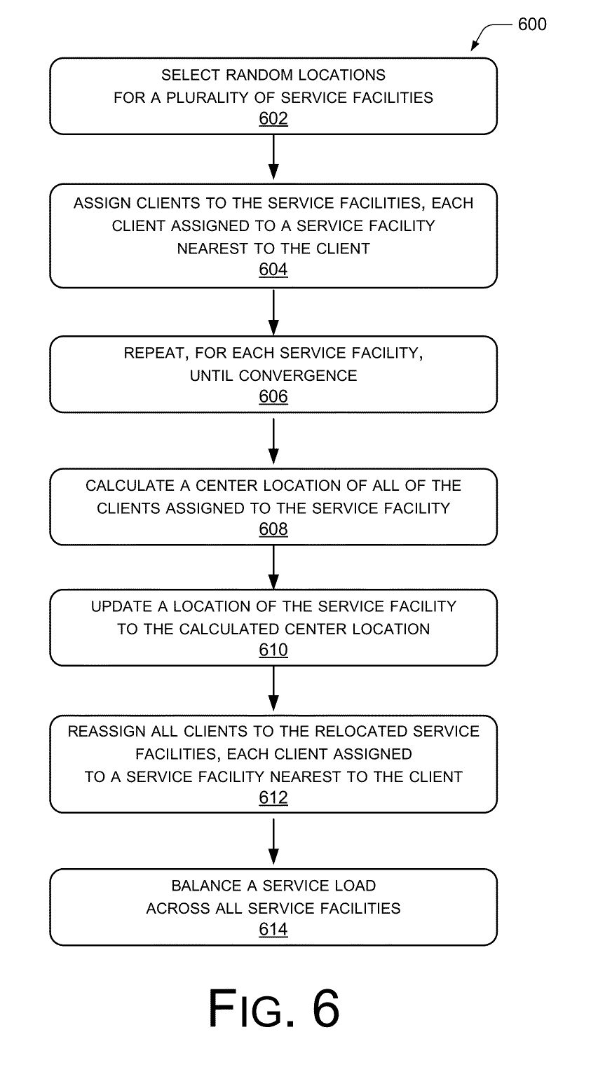

FIG. 6 is a flow diagram illustrating an example process 600 for optimizing placement of service facilities. For example, the process 600 considers load constraints of the service facilities while applying one or more algorithms to converge on an optimal placement. The process 600 is described with reference to FIGS. 1-5.

The order in which the process 600 is described is not intended to be construed as a limitation, and any number of the described process blocks can be combined in any order to implement the process, or alternate processes. Additionally, individual blocks may be deleted from the process without departing from the spirit and scope of the subject matter described herein. Furthermore, the process can be implemented with any suitable components, or combinations thereof, without departing from the scope of the subject matter described herein.

At block 602, the process includes selecting random locations for a plurality of service facilities. At block 604, the process includes assigning clients to the service facilities, where each client is assigned to a service facility nearest to the client. In an implementation, assigning clients to the service facilities comprises assigning each client to a service facility nearest to the client in Euclidean distance. In another implementation, assigning clients to the service facilities comprises assigning each client to a service facility with a minimum sum of Cartesian distances to the client.

In an implementation, the process includes iteratively converging on a service facility placement solution, including a geo-location of every service facility and an assignment of clients to each service facility, wherein the overall cost is minimized and the client load of every service facility is substantially balanced. In one example, a cost score of a service facility is defined by an average of distances from clients to the service facility.

In one implementation, convergence comprises less than a predetermined threshold of change of an objective function, after a preset quantity of iterations. At block 606, the process includes repeating, for each service facility, until convergence. At block 608, the process includes calculating a center location of all of the clients assigned to the service facility. At block 610, the process includes updating a location of the service facility to the calculated center location. At block 612, the process includes reassigning all clients to the relocated service facilities, in which each client is assigned to a service facility nearest to the client. And at block 614, the process includes balancing a service load across all service facilities.

In an implementation, the process includes using a balancing algorithm to reassign the clients to the relocated service facilities, the balancing algorithm includes the following steps: initialize a holding set as empty; put each facility of the plurality of facilities into the holding set when the load of the facility is higher than an average load of all of the facilities of the plurality; repeat for each facility of the plurality of facilities, until a load-balancing penalty cannot be decreased; identify a client with a minimum transfer cost in the holding set; transfer the client with the minimum transfer cost to its destination facility; and if an objective function is larger than a previous iteration, then put the client with the minimum transfer cost back to its original facility. In an implementation, the facility to which the transfer cost of the client is minimized is selected to be the client's destination facility.

In an implementation, the process includes modelling a city as a network, wherein buildings, intersections, event spots, and police substations comprise vertices and roads connecting them comprise edges, and wherein the edges represent travel time between nodes of the network. In the implementation, a load score of a substation is defined as a sum of distances of the substation to all of its assigned event spots, taking a shortest path in road distance for each of the distances.

In an implementation, the process includes using a heuristic method to find an approximate center of a set of event spots, including: determining an Euclidean center as a ‘seed’ center; identifying at least three nearest nodes to the Euclidean center as candidate nodes; calculating the actual shortest paths from each event spot to each candidate node; and selecting a candidate node having a minimum sum of distances from each of the event spots to the selected candidate node as the center of the event spots.

In alternate implementations, other techniques may be included in the process 600 in various combinations, and remain within the scope of the disclosure.

Portions of the subject matter of this disclosure can be implemented as a system, method, apparatus, or article of manufacture using standard programming and/or engineering techniques to produce software, firmware, hardware or any combination thereof to control a computer or processor (such as processor 106, for example) to implement the disclosure. For example, portions of an example system 100 may be implemented using any form of computer-readable media (shown as memory 104 in FIG. 1, for example) that is accessible by the processor 106. Computer-readable media may include, for example, computer storage media and communications media.

Computer-readable storage media includes volatile and nonvolatile, removable and non-removable media implemented in any method or technology for storage of information such as computer-readable instructions, data structures, program modules or other data. Memory 104 is an example of computer-readable storage media. Storage 112, which may comprise local, network, or cloud storage, for example, is another example of computer-readable storage media. Additional types of computer-readable storage media that may be present include, but are not limited to, RAM, ROM, EEPROM, flash memory or other memory technology, CD-ROM, digital versatile disks (DVD) or other optical storage, magnetic disks or other magnetic storage devices, or any other medium which may be used to store the desired information and which may accessed by the processor 106.

In contrast, communication media typically embodies computer readable instructions, data structures, program modules, or other data in a modulated data signal, such as a carrier wave, or other transport mechanism.

While the subject matter has been described above in the general context of computer-executable instructions of a computer program that runs on a computer and/or computers, those skilled in the art will recognize that the subject matter also may be implemented in combination with other program modules. Generally, program modules include routines, programs, components, data structures, and the like, which perform particular tasks and/or implement particular abstract data types.

Moreover, those skilled in the art will appreciate that the innovative techniques can be practiced with other computer system configurations, including single-processor or multiprocessor computer systems, mini-computing devices, mainframe computers, as well as personal computers, hand-held computing devices, microprocessor-based or programmable consumer or industrial electronics, and the like. The illustrated aspects may also be practiced in distributed computing environments where tasks are performed by remote processing devices that are linked through a communications network. However, some, if not all aspects of the disclosure can be practiced on stand-alone computers. In a distributed computing environment, program modules may be located in both local and remote memory storage devices.

Although implementations have been described in language specific to structural features and/or methodological acts, it is to be understood that the subject matter defined in the appended claims is not necessarily limited to the specific features or acts described above. Rather, the specific features and acts are disclosed as illustrative forms of illustrative implementations. For example, the methodological acts need not be performed in the order or combinations described herein, and may be performed in any combination of one or more acts.

What is claimed is:

1. Non-transitory computer-readable storage media, having computer-executable instructions stored thereon, that when executed, cause a computer processor to initiate a process, comprising:
selecting random locations for a plurality of police substations within a city;
assigning event spots to the substations, each event spot assigned to a substation nearest to the event spot;
repeating, for each substation, until convergence:
calculating a center location of all of the event spots assigned to the substation;
updating a location of the substation to the calculated center location;
reassigning all event spots to the relocated substations, each event spot assigned to a substation nearest to the event spot; and
balancing a service load across all substations.

2. The computer readable storage media of claim 1, further comprising using previous locations for the plurality of police substations and/or using previous assignments for the event spots instead of selecting random locations for the plurality of substations and assigning event spots to the substations when a distribution of event spots changes within the city and/or when an assignment of police officers changes with regard to the substations.

3. A system, comprising:
a processor;
a memory hardware device communicatively coupled to the processor;
a load-constrained service facility placement arrangement stored in the memory hardware device and operative on the processor to:
select random locations for a plurality of service facilities;
assign clients to the service facilities, each client assigned to a service facility nearest to the client;
repeat, for each service facility, until convergence:
calculate a center location of all of the clients assigned to the service facility;
update a location of the service facility to the calculated center location;
reassign all clients to the relocated service facilities, each client assigned to a service facility nearest to the client; and
balance a service load across all service facilities.

4. The system of claim 3, further comprising an input/output component arranged to receive location information regarding the plurality of service facilities, the location information used to determine distances from the service facilities to the clients.

5. The system of claim 3, wherein the load-constrained service facility placement arrangement is arranged to modify an algorithm that solves a K-means clustering problem, and wherein with each iteration of the modified algorithm, cluster centers or facility locations are updated, and also assignment of transfer data points or clients between clusters are updated to maintain a predetermined load constraint.

6. The system of claim 3, wherein the system is arranged to geo-locate police substations at optimal locations within a portion of a city, such that a response time from the substations to event spots within the city is minimized and such that a load of each of the substations is substantially balanced.

7. The system of claim 6, wherein a load score of a police substation is defined as a sum of distances from that substation to all of its corresponding event spots, and wherein the load score of each substation is used to balance loads at the substations.

8. The system of claim 7, wherein load-constrained service facility placement arrangement is arranged to balance a load of each substation via an algorithm arranged to minimize a load-balancing penalty based on the load score.

9. The system of claim 6, wherein the system is arranged to geo-locate the police substations and to balance a load of each substation based on a quantity of police officers assigned to each substation.

10. A method, comprising:
selecting random locations for a plurality of service facilities;
assigning clients to the service facilities, each client assigned to a service facility nearest to the client;
repeating, for each service facility, until convergence:
calculating a center location of all of the clients assigned to the service facility;
updating a location of the service facility to the calculated center location;
reassigning all clients to the relocated service facilities, each client assigned to a service facility nearest to the client; and
balancing a service load across all service facilities.

11. The method of claim 10, further comprising using a balancing algorithm to reassign the clients to the relocated service facilities, the balancing algorithm including:
initialize a holding set as empty;
put each facility of the plurality of facilities into the holding set when the load of the facility is higher than an average load of all of the facilities of the plurality;
repeat for each facility of the plurality of facilities, until a load-balancing penalty cannot be decreased;
identify a client with a minimum transfer cost in the holding set;
transfer the client with the minimum transfer cost to its destination facility; and
if an objective function is larger than a previous iteration, then put the client with the minimum transfer cost back to its original facility.

12. The method of claim 11, wherein the facility to which the transfer cost of the client is minimized is selected to be the client's destination facility.

13. The method of claim 10, further comprising iteratively converging on a service facility placement solution, including a geo-location of every service facility and an assignment of clients to each service facility, wherein the overall cost is minimized and the client load of every service facility is substantially balanced.

14. The method of claim 13, wherein a cost score of a service facility is defined by an average of distances from clients to the service facility.

15. The method of claim 10, further comprising modelling a city as a network, wherein buildings, intersections, event spots, and police substations comprise vertices and roads connecting them comprise edges, and wherein the edges represent travel time between nodes of the network.

16. The method of claim 15, wherein a load score of a substation is defined as a sum of distances of the substation to all of its assigned event spots, taking a shortest path in road distance for each of the distances.

17. The method of claim 10, further comprising using a heuristic method to find an approximate center of a set of event spots, including:
determining an Euclidean center as a ‘seed’ center;
identifying at least three nearest nodes to the Euclidean center as candidate nodes;
calculating the actual shortest paths from each event spot to each candidate node; and
selecting a candidate node having a minimum sum of distances from each of the event spots to the selected candidate node as the center of the event spots.

18. The method of claim 10, wherein assigning clients to the service facilities comprises assigning each client to a service facility nearest to the client in Euclidean distance.

19. The method of claim 10, wherein assigning clients to the service facilities comprises assigning each client to a service facility with a minimum sum of Cartesian distances to the client.

20. The method of claim 10, wherein convergence comprises less than a predetermined threshold of change of an objective function, after a preset quantity of iterations.
